(19) United States
(12) Patent Application Publication
(10) Pub. No.: US 2017/0361531 A1
(43) Pub. Date: Dec. 21, 2017

(54) USE OF CORE-SHELL(-SHELL) PARTICLES IN THE BINDER JETTING PROCESS

(71) Applicant: Evonik Roehm GmbH, Darmstadt (DE)

(72) Inventors: Thomas HASSKERL, Kronberg (DE); Lukas Friedrich DOESSEL, Darmstadt (DE)

(73) Assignee: Evonik Roehm GmbH, Darmstadt (DE)

(21) Appl. No.: 15/625,653

(22) Filed: Jun. 16, 2017

(30) Foreign Application Priority Data
Jun. 20, 2016 (EP) 16175258

(51) Int. Cl. B29C 64/153; B01J 13/16; B33Y 70/00; B33Y 10/00; C09D 133/12; C08J 3/12

(52) U.S. Cl. CPC B29C 64/153; C09D 133/12; C08J 3/126; B33Y 70/00; B33Y 10/00; B01J 13/16; C08J 2333/08; C08J 2433/12

(57) ABSTRACT

A three-dimensional object is formed by 3D printing, especially by a binder jetting method, in which particulate material in a powder bed is bonded by a printed adhesive. The particulate materials may be inorganic materials, for example sand or a metal powder, or particulate polymeric materials, for example polymethacrylates or polyamides. For this purpose, polymethacrylates may take the form, for example, of suspension polymers, called bead polymers. Powder bed compositions comprising core-(shell)-shell particles can be used for 3D printing, wherein the core-(shell)-shell particles can swell in contact with the binder during the printing operation.

### BACKGROUND OF THE INVENTION

### Field of the Invention

The present invention relates to the technical field of 3D printing, especially in the form of the binder jotting method, in which particulate material in a powder bed is bonded by means of a printed adhesive to form a three-dimensional object. The particulate materials may be inorganic materials, for example sand or a metal powder, or particulate polymeric materials, for example polymethacrylates or polyamides. For this purpose, polymethacrylates may take the form, for example, of suspension polymers, called head polymers.

The present invention relates more particularly to powder bed compositions comprising core-(shell-)shell particles for 3D printing, which differ from the prior art in that the core-(shell-)shell particles can swell in contact with the binder during the printing operation.

### Description of the Related Art

Binder jetting is an additive production process which is also known by the term “3D inkjet powder printing”, which gives a good description of the method. This method involves applying a liquid binder, for example by means of a standard inkjet printhead, to a powder layer and hence selectively bonding a portion of this powder layer together. The application of new powder layers which alternates with this application ultimately results in formation of a three-dimensional product. In this process in particular an inkjet printing head moves selectively across a powder bed and prints the liquid binder material precisely at the locations that are to be hardened. An example of the hardening procedure is the reaction between liquid vinylic monomers in the ink and peroxides present in the powder. The reaction is accelerated by a catalyst, for example based on an amine, to such an extent that it takes place at room temperature. The process is repeated layer-by-layer until a finished moulding has been produced. Once the printing process has ended, the moulding can be removed from the powder bed and optionally introduced into a post-treatment procedure. Such an aftertreatment is often necessary in order to improve the mechanical stability of the end product and consists, for example, of sintering, infiltration, irradiation or spraying with a further binder or hardener. However, such an aftertreatment step makes the process more complex in an undesirable manner. These downstream operations are still undesirable because shrinkage still often occurs and can adversely affect dimensional stability.

In binder jetting, it is possible to use various materials as binders and as powder material. Suitable powder materials are, for example, polymer particles, sand, ceramic particles or metal powders each having a diameter between 10 and a few hundred μm. In the case of use of sand, there is usually no need for reprocessing of the finished article. In the case of other materials, for example the polymer powders including PMMA, subsequent curing, sintering and/or infiltration of the article may be necessary. However, such subsequent processing is actually undesirable since it is time-consuming and/or costly and, because of shrinkage that often occurs, can lead to an adverse effect on dimensional stability.

Polymer powders based on suspension polymers have in particular been used hitherto. The size of the polymer particles is generally from some tens of microns to some hundreds of microns. These particles feature good powder-flowability, do not cake, and give good results from application in the form of powder bed. If polymer particles comprising peroxides are used, it is easy to achieve reaction with the (meth)acrylate-containing binder. The disadvantage of a powder bed composed of abovementioned particles is the porosity of the resultant mouldings, because the liquid binder cannot fill all of the cavities.

The binder is generally applied in an analogous manner to conventional two-dimensional paper printing. Examples of binder systems are liquid vinylic monomers which are cured by means of peroxides present in the powder material. Alternatively or additionally, the powder material comprises a catalyst which accelerates curing or actually enables it at the ambient temperature. Examples of such a catalyst for acrylate resins or monomers with peroxides as initiator are amines, especially secondary amines.

Binder jetting has great advantages over other 3D printing methods such as FDM or SLS, which are based on melting or welding of the material that forms the product. For instance, this method has the best suitability among all known methods for directly realizing coloured objects without subsequent colouring. This method is also especially suitable for producing particularly large articles. For instance, products up to the size of a room have been described. Moreover, other methods are also very time-consuming in terms of the overall printing operation up to the finished object. Apart from any necessary reprocessing, binder jetting can even be considered to be particularly time-efficient compared to the other methods.

Furthermore, binder jetting has the great advantage over other methods that it is effected without supply of heat. In the case of methods effected by means of melting or welding, this inhomogeneous introduction of heat gives rise to stresses in the product, which usually have to be dissipated again in subsequent steps such as a thermal aftertreatment, which means further expenditure of time and costs.

A disadvantage of binder jetting is the method-related porosity of the product. For instance, for objects printed by means of binder jetting, only tensile strengths about 20 times smaller than the injection mouldings made from a comparable material are achieved. Because of this disadvantage, the binder jetting method has to date been used predominantly for production of decorative pieces or for casting sand moulds. The porosity arises particularly from the fact that only some of the cavities between the particles are filled by the binder in known printing methods. This is an inevitable result of the low viscosity of the liquid binders applied by printing. Should more be applied, this runs into neighbouring particles or cavities between the particles (called gaps) directly before and also during the commencement of curing. This in turn leads to an imprecise, non-clean impression of the print, or to a low surface accuracy in the finished article.

The porosity is increased by the fact that polymer powders based on suspension polymers have been used to date. The size of the polymer particles is generally from some tens of micrometres to some hundreds of micrometres. These particles feature good powder-flowability, do not cake, and give good results from application in the form of powder bed. However, the disadvantage of a powder bed which is formed exclusively from suspension polymers is the high porosity of the shaped bodies produced therewith, which arises as a result of the relatively large gaps in such a powder bed.

J. Presser, in his thesis “Neue Komponenten fur das generative Fertigungsverfahren des 3D-Drucks” [New Components for the Additive Manufacturing Method of 3D Printing] (TU Darmstadt, 2012), describes the use of precipitated emulsion polymers in powder form for the binder jetting method. For this purpose, these emulsion polymers partly fill the interstices between the actual particles and hence lead to a reduction in porosity. However, processing via coagulation, drying and sieving leads to non-round secondary particles of irregular size distribution. Moreover, it has been found that the emulsion polymers used in this way barely increase the bulk density and do not have any significant effect in relation to the stability of the printed object.

### SUMMARY OF THE INVENTION

The problem underlying the present invention was that of improving the binder jetting method in such a way that objects can be printed with distinctly improved mechanical properties compared to the prior art and simultaneously a good surface appearance, without any need for time-consuming reprocessing of the product.

A further problem addressed was that of improving the mechanical stability of products of a binder jetting method, especially those based on a polymer powder, especially a PMMA powder, such that they can be used as functional components.

A particular problem addressed in this context was that of realizing mouldings which have at least 30% of the tensile modulus of elasticity of an analogous injection-moulded part. “Analogous” means here by way of example that a PMMA injection moulding is compared with a binder jetting product based on a PMMA powder.

A further problem addressed was that of improving the mechanical stability of products of a binder jetting method, especially those based on a polymer powder, especially a PMMA powder, such that they can be used as functional components.

Other problems that are not mentioned explicitly may become apparent from the description, the examples or the claims of the present application, or from the overall context thereof.

These problems are solved by using, in accordance with the invention, in a method for producing three-dimensional objects from a powder bed by means of a binder jetting method, small particles which at least partly till the cavities between the particles of the powder and give rise to a firm bond with elevated mechanical stability in the reaction between the binder and the peroxide. These second particles used in accordance with the invention can be produced, for example, by emulsion polymerization in the aqueous phase by a staged process. A preferred process is a two- or three-stage emulsion polymerization process in which, in the first step, a core is produced with a particular composition and a particular glass transition temperature. In the second step, a shell made of the same polymer or preferably a different polymer is polymerized onto the core, and in a third stage a second shell is optionally polymerized onto this first shell. The compositions for production of the core and the shell(s) are appropriately chosen such that they exert a positive effect on the mechanical properties of the shaped body produced by the binder jetting operation.

### DETAILED DESCRIPTION OF THE INVENTION

The invention concerns a method of producing three-dimensional objects from a powder bed by means of a binder jetting method, which is characterized by multiple repetition of the following process steps:

a) applying a new powder layer on the surface of the powder bed and

b) selectively applying a binder and subsequently or simultaneously curing this binder in the powder bed.

According to the invention, this powder bed comprises at least two different kinds of particulate material. The first particulate material has a mean diameter between 10 and 500 μm, preferably 30 and 110 μm and more preferably 35 and 100 μm, which corresponds roughly to the particles already being used according to the prior art. Preferably, the first particulate material is a PMMA suspension polymer.

According to the invention, these first particles, however, are mixed with a second kind of particles in the powder bed, this second particulate material comprising core-shell or core-shell-shell particles having a mean diameter between 100 nm and 1200 nm.

In a particular embodiment, the core of the polymer, which in that case is a core-shell particle, is somewhat harder than the shell, by means of which it is possible to increase the heat distortion resistance of the 3D shaped body. In this execution, the shell of the emulsion polymer is made somewhat softer than the core, in order to obtain a certain swellability via the liquid binder and at the same time surprisingly to form a composite having good cohesion with the particles of the powder bed. The softness or the hardness of shell and core can be adjusted, for example, through the choice of suitable monomers or oligomers, via the glass transition temperature of their polymers. The glass transition temperature has to be chosen here such that, on the one hand, there is no caking of the powder in the course of handling and, on the other hand, there is sufficient swellability via the liquid binder. The choice of glass transition temperature can be made, for example, through the combination of “hard” and “soft” monomers or through the choice of a single monomer. The framework within which this selection can be made can be decided by the person skilled in the art in a simple manner on the basis of the properties mentioned. More particularly, in such an embodiment, the second particulate material comprises core-shell particles having a core which, measured by means of DSC, has a higher glass transition temperature than the shell by at least 20° C., preferably at least 30° C., more preferably at least 40° C.

In another, likewise preferred embodiment, the shell of a core-shell particle, generally in the form of an emulsion polymer, is made somewhat harder than the core, by means of which the tackiness of the material can be controlled and lowered to an acceptable level. In this execution, the thickness of the shell is adjusted such that, on the one hand, it prevents the particles from sticking in the course of handling and, on the other hand, it is sufficiently thin, such that, surprisingly, it can be penetrated by the liquid binder and permits swelling of the particle within an appropriate time. To control the swellability, the outer shell can more preferably be crosslinked. The degree of crosslinking of the shell is preferably chosen so as to result in sufficient time for swelling with the timespan available in the printing process and given the choice of liquid binder. The framework within which this selection can be made can likewise be decided by the person skilled in the art in a simple manner on the basis of the properties mentioned. More particularly, in such an embodiment, the second particulate material comprises core-shell particles having a shell which, measured by means of DSC, has a higher glass transition temperature than the core by at least 20° C., preferably at least 30° C., more preferably at least 40° C.

In a third, particularly preferred embodiment, second particles having a core-shell-shell structure are used. One example of a very particularly preferred embodiment of this variant is that of particles, especially emulsion polymers, composed of a hard core, a soft first shell and a hard second shell. In this particle structure, the glass transition temperature of the composite can be kept high by means of a hard core, while the soft first shell ensures good swellability by the liquid binder. The hard outer shell provides protection from sticking in the course of handling and use, but is only so thick that it can be penetrated by the binder. More particularly, suitable second particles here are those in which the inner shell, measured by means of DSC. has a glass transition temperature lower than the core and the outer shell by at least 20° C., preferably at least 30° C., more preferably at least 40° C.

In a fourth alternative, likewise preferred embodiment of the present invention, particles having a core-shell-shell structure are likewise used. One example of a particularly preferred embodiment is that of panicles composed of a soft core, a hard first shell and a second swellable, possibly somewhat softer shell. This particle architecture surprisingly allows an increase in the impact resistance of the composite, caused by the elastomeric soft core, while the first hard shell prevents the caking of the particles. The second swellable and possibly somewhat softer shell is designed such that it permits swelling, but prevents premature caking in the course of handling and use. Suitable formulations for the outer shell include combinations of hard and soft monomers, molecular weight regulators and crosslinkers. Through the choice of the components, as described above, a balance is established between the properties, such that sufficient swellability and prevention of sticking are ensured. In this embodiment, soluble polymer constituents in the outer shell can bring about an additional positive effect through thickening of the liquid binder.

Irrespective of which of these four embodiments of the invention is chosen by the person skilled in the art, or whether two or more of these embodiments are actually combined with one another, the following surprising effects will be obtained as a result:
Increase in powder bed density through mixing of emulsion and suspension polymers and hence a lower porosity and better mechanical stability of the end product.
Swelling of the second particles, especially in the form of emulsion polymers, under pressure, as a function of the degree of crosslinking, and hence, in principle, a clean printed image having better resolution.
A printed image with a better surface appearance, because it is smoother.

Optionally—according to the rest of the embodiment—it is also possible for one shell, the shell or both shells to be constructed in such a way that oligomeric or polymeric constituents, or those of low molecular weight, that are not bonded in a covalent manner to the second particulate material and are soluble on contact of the second particulate material with a solvent or a monomer are leached out of the shell by the liquid binder and increase the porosity of the shell, such that it becomes swellable. This is possible, for example, through the use of molecular weight regulators in the shell. The combination of crosslinkers and molecular weight regulators gives rise to a portion of polymer chains that have not been grafted on and can be detached or dissolved by the liquid binder. While, for example, a comparatively hard, relatively short-chain polymer having a high glass transition temperature provides protection from caking of the polymer particles, swelling of the shell can be improved after this component has been leached out of the shell. At the same time, the dissolved polymer thickens the liquid binder and thus effectively prevents the unwanted incipient swelling of lower-lying layers, which additionally promotes image accuracy once again. More preferably, the leachable constituents are part of the outermost shell present in the second particulate material.

Preferably, the oligomeric or polymeric constituents are formed by the use of 0.1% to 8% by weight, more preferably 1% to 5% by weight, of a chain transfer agent in the monomer mixture for production of the core and/or the shell(s), preferably at least one shell of the second particulate material. Most preferably, the outermost shell present in the second particulate material was produced from a composition comprising the chain transfer agent.

With regard to the implementation of such soluble constituents, the following can be stated in general terms: For example, using more chain transfer agent will give rise to shorter chains and a greater amount of soluble polymers. Using less chain transfer agent will give rise to longer polymer chains and a smaller amount of soluble polymers. Using less crosslinker will give rise, in combination with the chain transfer agent content, to a greater amount of soluble polymers and, conversely, a smaller amount of soluble polymers will arise on use of a higher crosslinker concentration.

Irrespective of the further embodiment of the present invention, it is advantageous when the core or the shell having a lower glass transition temperature is a phase which has been produced to an extent of at least 60% by weight from acrylates and has a glass transition temperature measured by DSC which is at least 40° C. below the glass transition temperature measured by DSC of the first particulate material.

Irrespective of this, but more preferably simultaneously with the latter execution of the invention, the phase of the particulate polymer material having a higher glass transition temperature is preferably a phase which has been produced to an extent of at least 60% by weight from MMA and has a glass transition temperature determined by means of DSC greater than 80° C.

Irrespective of this, but more preferably simultaneously with the two latter executions or with the other executions of the invention that have been cited, the second particulate material is preferably one in which the core or the shell having a lower glass transition temperature has a glass transition temperature less than 40° C., and the core and/or the shell having a higher glass transition temperature has a glass transition temperature greater than 80° C.

It is optionally also possible that the powder bed comprises at least two different particles of the second particles described.

In a very particular embodiment of the present invention, the first and/or second particulate material is preferably a particulate polymer material comprising an initiator suitable for curing the binder or a catalyst or accelerator that accelerates the curing. The initiators mentioned may, for example, be peroxides or azo initiators that are common knowledge to the person skilled in the art. The accelerators are by way of example compounds which, in combination with an initiator, which in turn per se has a relatively high decomposition temperature, lower the decomposition temperature of this initiator. This allows curing to begin at a temperature as low as ambient temperature in the printer, or during a heat-conditioning step extending to 50° C. Examples of a suitable initiator with high decomposition temperature here would be secondary or tertiary, mostly aromatic amines. Catalysts mentioned can have a corresponding or similar activating effect. However, it is generally a simple matter for the person skilled in the art to select the precise composition of the initiator system.

Suspension polymers used for production of the first particles are by way of example pulverulent materials which are produced by free-radical polymerization in the presence of water and which have a volume-average median particle diameter (d50) within the range specified further up. It is particularly preferable that the suspension polymers are PMMA or are MMA copolymers. To this end, the comonomers can be selected by way of example from the group of the acrylates, methacrylates and styrene or styrene derivatives.

Preferably, the monomer phase for production of the shell, or shells, more preferably of the outermost shell present in the second particulate material, comprises at least one crosslinker. It is especially preferable that this phase comprises from 0.1% to 10% by weight, particularly from 1% to 5% by weight, of crosslinker. Particularly preferred crosslinkers are di- or tri(meth)acrylates.

The weight ratio of the first particles to the second particles in the powder bed is more preferably between 99:1 and 9:1, preferably between 40:1 and 20:1.

According to the invention, all glass transition temperatures are determined by means of DSC. In this regard, the person skilled in the art is aware that DSC is only sufficiently conclusive ⁻when, after a first heating cycle up to a temperature Which is a minimum of 25° C. above the highest glass transition or melting temperature but at least 20° C. below the lowermost breakdown temperature of a material, the material sample is kept at this temperature for at least 2 min. Thereafter, the sample is cooled back down to a temperature at least 20° C. below the lowermost glass transition or melting temperature to be determined, where the cooling rate should be not more than 20° C./min, preferably not more than 10° C./min. After a further wait time of a few minutes, the actual measurement is effected, in which the sample is heated at a heating rate of generally 10° C./min or less up to at least 20° C. above the highest melting or glass transition temperature. The respective highest and lowest temperature limits can be roughly predetermined in simple preliminary measurements with a separate sample.

The particle sizes were measured to DIN ISO 13321:2004-10, based on the identical wording adopted from the international standard ISO 13321:1996, by means of an N5 submicron particle size analyser from Beckman Coulter Inc.

The detailed descriptions provided below serve to illustrate a preferred embodiment in terms of the enablement thereof. However, these descriptions are not intended to restrict the present invention in any way:

Having generally described this invention, a further understanding can be obtained by reference to certain specific examples which are provided herein for purposes of illustration only, and are not intended to be limiting unless otherwise specified.

### EXAMPLES

General, illustrative description for production of the emulsion polymers according to the invention:

Emulsion polymerization of core-shell and core-shell-shell emulsion polymers for production of polymer particles for binder jetting

Emulsion polymers having a multiphase core/shell(/shell) architecture can be used as polymer particles for binder jetting. They are obtainable, for example, by a three-stage emulsion polymerization by a process in which
a) water and emulsifier are initially charged,
b) 0-45 parts by weight of a first composition comprising components A), B), C) and D) are added and polymerized up to a conversion of at least 85% by weight, based on the total weight of components A), B), C) and D),
c) 35.0-80.0 parts by weight of a second composition comprising components E), F) and G) are added and polymerized up to a conversion of at least 85% by weight, based on the total weight of components E), F) and G),
d) 15.0-40.0 parts by weight of a third composition comprising components I) and J) are added and polymerized up to a conversion of at least 85% by weight, based on the total weight of components H), I) and J),
e) where the stated proportions by weight of compositions b), c) and d) add up to 100 parts by weight.

In step a), preferably 90 to 99.99 parts by weight of water and 0.01 to 10 parts of emulsifier are initially charged, where the stated proportions by weight add up to 100 parts by weight.

The polymerizations h), c) and d) can be conducted by thermal means at a temperature between 60 and 90° C., preferably 70 to 85° C. and preferably 75 to 85° C., or be initiated by a redox initiator system.

The initiation can be effected with the initiators that are commonly used for emulsion polymerization. Suitable organic initiators are, for example, hydroperoxides such as t-butyl hydroperoxide or cumene hydroperoxide. Suitable inorganic initiators are hydrogen peroxide and alkali metal and ammonium salts of peroxodisulphuric acid, especially potassium peroxodisulphate and sodium peroxodisulphate. Said initiators can be used individually or as a mixture. They are preferably used in an amount of 0.05 to 3.0 parts by weight, based on the total weight of the monomers in the particular stage.

The mixture can be stabilized by means of emulsifiers and/or protective colloids. Preference is given to stabilization by means of emulsifiers, in order to obtain a low dispersion viscosity. The total amount of emulsifier is preferably 0.1 to 5.0 parts by weight, especially 0.5 to 3.0 parts by weight, based on the total weight of monomers A) to J).

Particularly suitable emulsifiers are anionic and/or nonionic emulsifiers or mixtures thereof, especially alkyl sulphates, alkyl and alkylaryl ether sulphates, sulphonates, preferably alkylsulphonates, esters and monoesters of sulphosuccinic acid, phosphoric acid partial esters and salts thereof, alkyl polyglycol ethers, alkylaryl polyglycol ethers and ethylene oxide-propylene oxide copolymers.

The initiator can be initially charged or metered in. In addition, it is also possible to initially charge a portion of the initiator and to meter in the remainder. Initiator and emulsifier can be metered in separately or as a mixture. Preferably, the metered addition is commenced 15 to 35 minutes after commencement of the polymerization.

In addition, it is particularly advantageous for the initial charge to contain what is called a seed latex having a particle size between 10 and 40 inn, measured by the laser diffraction method, as supplied, for example, by Beckman Coulter or Malvern.

Preferably, the polymerization is initiated by heating the mixture and metering in the initiator. The metered additions of emulsifier and monomers can be effected separately or together.

Added to the seed latex are the monomer constituents of the actual core, i.e. the first composition, under such conditions that the formation of new particles is avoided, which results in growth of the shell material on the existing core. This procedure is applicable mutatis mutandis to all stages.

The adjustment of the chain length, especially of the polymers of the second shell (third composition), can be effected using molecular weight regulators, preferably mercaptans.

The core-shell(-shell) particle according to the invention can be obtained from the dispersion, for example, by spray-drying, freeze coagulation, precipitation by electrolyte addition, or by mechanical or thermal stress.

The term “styrenic monomers” as used hereinafter is understood to mean derivatives of styrene. The suitable derivatives include those which have substituents on the phenyl ring of the styrene and unsubstituted styrene.

The first composition according to b) comprises
A) 50 to 99.9 parts by weight of alkyl methacrylates
B) 0 to 4(i parts by weight of alkyl acrylates
C) 0 to 10 parts by weight of crosslinking monomers
D) 0 to 8 parts by weight of styrenic monomers

The second composition according to c) comprises
E) 80 to 100 parts of monofunctional (meth)acrylates
F) 0.05% to 5% crosslinking monomers
G) 0% to 25% styrenic monomers

The monomer selection of the monomers E), F) and G) is effected in such a way that the glass transition temperature of the resulting copolymer is preferably less than 10° C. especially between 0 and −75° C., measured by DSC (differential scanning calorimetry).

The third composition d) for the core-shell-shell particles comprises
H) 50 to 100 parts by weight of alkyl methacrylates
I) 0 to 40 parts by weight of alkyl acrylates
J) 0 to 10 parts by weight of styrenic monomers
K) 0% to 5% crosslinking monomers

### SPECIFIC EXAMPLES

Core-Shell-Shell Particles I.

### Example 1

Production of the Seed Latex

A seed latex was produced by means of emulsion polymerization of a monomer composition containing 98% by weight of ethyl acrylate and 2% by weight of allyl methacrylate. These particles having a diameter of about 2.0 nm were present in a concentration of about 10% by weight in water. By polymerization of a shell onto the seed latex, it is possible to produce seed latices having particles of up to 300 nm in size. Through use of large particles in the seed latex, it is possible to produce very large particles of diameter up to 1 μm in the three-stage process.

Production of the Core-Shell-Shell Particles

All the core-shell-shell particles described hereinafter were produced by means of emulsion polymerization according to Preparation Method A below (Inventive Examples I1, I2, I3, I4 and I5). This was done using the emulsions (i) to (iii) specified in Table 1. In addition, Example 6, Method B, is specified as a further variant with a separate description

### Examples I1, I2, I3, I4 and I5

Production of the Core-Shell-Shell Particles by Preparation Method A

At 83° C. (internal tank temperature), 1.711 kg of water were initially charged in a stirred polymerization tank. 1.37 g of sodium carbonate and seed latex were added. Subsequently, emulsion (i) was metered in over the course of 1 h. 10 min after the feeding of emulsion (i) had ended, emulsion (ii) was metered in over a period of about 2 h. Subsequently, about 60 min after the feeding of emulsion (ii) had ended, emulsion (iii) was metered in over a period of about 1 h. 30 min after the feeding of emulsion (iii) had ended, the mixture was cooled to 30° C.

To separate the core-shell-shell particles, the dispersion was frozen at −20° C. for 2 days, then thawed again, and the coagulated dispersion was separated by means of a filter fabric. The solids were dried at 50° C. in a drying cabinet (for about 3 days). The particle size of the core-shell-shell particles (see Table 2) was determined by means of a Coulter Nano-Sizer© N5. by analysing the particles in dispersion.

### Example I6

### Method B

Production of the Core-Shell-Shell Particles by Preparation Method B

At 52° C. (internal tank temperature), 1.711 kg of water were initially charged in a stirred polymerization tank, and 0.10 g of acetic acid, 0.0034 g of iron(II) sulphate, 0.69 g of sodium disulphite and the seed latex were added. Subsequently, emulsion (i) was metered in over the course of 1.5 h. 10 min after the feeding of emulsion (i) had ended, 7.46 g of sodium disulphite dissolved in 100 g of water were added and emulsion (ii) was metered in over a period of about 2.5 h. Subsequently, about 30 min after the feeding of emulsion (ii) had ended, 0.62 g of sodium disulphite dissolved in 50 g of water were added and emulsion (iii) was metered in over a period of about 1.5 h. 30 min after the feeding of emulsion (iii) had ended, the mixture was cooled to 30° C.

To separate the core-shell-shell particles, the dispersion was frozen at −20° C. for 2 days, then thawed again, and the coagulated dispersion was separated by means of a filter fabric. The solids were dried at 50° C. in a drying cabinet (for about 3 days). The particle size of the core-shell-shell particles (see Table 2) was determined by means of a Coulter Nano-Sizer© N5, by analysing the particles in dispersion.

TABLE 1
Summary of the individual emulsions (all figures in [g])

| | I1 | I2 | I3 | I4 | I5 | I6 |
|---|---|---|---|---|---|---|
| Seed latex | 93.00 | 58.00 | 28.00 | 20.00 | 16.00 | 5.00 |
| Emulsion (i) | | | | | | |
| Water | 878.70 | 878.70 | 878.70 | 878.70 | 878.70 | 732.69 |
| Sodium | 0.70 | 0.70 | 0.70 | 0.70 | 0.70 | 0.51 |
| persulphate | | | | | | |
| Aerosol | 5.60 | 5.60 | 5.60 | 5.60 | 5.60 | 4.67 |
| OT75 | | | | | | |
| Methyl | 1071.62 | 1071.62 | 1071.62 | 1071.62 | 1071.62 | 703.47 |
| methacrylate | | | | | | |
| Ethyl | 44.74 | 44.74 | 44.74 | 44.74 | 44.74 | 29.40 |
| acrylate | | | | | | |
| Allyl | 2.24 | 2.24 | 2.24 | 2.24 | 2.24 | 2.21 |
| methacrylate | | | | | | |
| Emulsion (ii) | | | | | | |
| Water | 606.90 | 606.90 | 606.90 | 606.90 | 606.90 | 628.65 |
| Sodium | 1.58 | 1.58 | 1.58 | 1.58 | 1.58 | 1.44 |
| persulphate | | | | | | |
| Aerosol | 7.20 | 7.20 | 7.20 | 7.20 | 7.20 | 7.46 |
| OT75 | | | | | | |
| Butyl | 1160.63 | 1160.63 | 1160.63 | 1160.63 | 1160.63 | 1219.72 |
| acrylate | | | | | | |
| Styrene | 256.00 | 256.00 | 256.00 | 256.00 | 256.00 | 262.87 |
| Allyl | 21.57 | 21.57 | 21.57 | 21.57 | 21.57 | 19.53 |
| methacrylate | | | | | | |
| Emulsion (iii) | | | | | | |
| Water | 404.30 | 404.30 | 404.30 | 404.30 | 404.30 | 381.56 |
| Sodium | 0.70 | 0.70 | 0.70 | 0.70 | 0.70 | 0.44 |
| persulphate | | | | | | |
| Aerosol | 1.08 | 1.08 | 1.08 | 1.08 | 1.08 | 1.34 |
| OT75 | | | | | | |
| Methyl | 614.27 | 614.27 | 614.27 | 614.27 | 614.27 | 920.45 |
| methacrylate | | | | | | |
| Ethyl | 24.93 | 24.93 | 24.93 | 24.93 | 24.93 | 38.35 |
| acrylate | | | | | | |

TABLE 2
Particle sizes of the polymer particles

| | Core-shell-shell particles | | | | |
|---|---|---|---|---|---|
| | I1 | I2 | I3 | I4 | I6 |
| Particle radius [nm] | 72 | 88 | 101 | 116 | 165 |

Through use of the abovementioned large seed latices, it is possible to produce larger particles of up to 1000 nm in diameter in an analogous manner.

European patent application EP16175258 filed Jun. 20, 2016, is incorporated herein by reference.

Numerous modifications and variations on the present invention are possible in light of the above teachings. It is therefore to be understood that within the scope of the appended claims, the invention may be practiced otherwise than as specifically described herein.

1. A method of producing a three-dimensional object from a powder bed by a binder jetting process, said process comprising:
repeating multiple times the following
a) applying a new powder layer on a surface of the powder bed, and
b) selectively applying a binder and subsequently or simultaneously hardening said binder in the powder bed,
wherein the powder bed comprises at least two different types of particulate material,
wherein the first particulate material has a mean diameter between 10 and 500 μm,
wherein the second particulate material comprises core-shell or core-shell-shell particles having a mean diameter between 100 nm and 1200 nm.

2. The method according to claim 1, wherein the first particulate material comprises a PMMA suspension polymer having a mean diameter between 30 and 110 μm.

3. The method according to claim 1, wherein the second particulate material comprises an emulsion polymer having a core onto which two shells have been grafted.

4. The method according to claim 1, wherein the second particulate material comprises core-shell particles, wherein the core, as measured by Differential Scanning Calorimetry (DSC), has a glass transition temperature at least 20° C. higher than the shell.

5. The method according to claim 1, wherein the second particulate material comprises core-shell particles, wherein the shell, as measured by DSC, has a glass transition temperature at least 20° C. higher than the core.

6. The method according to claim 3, wherein an inner shell, as measured by DSC, has a glass transition temperature at least 20° C. lower than the core and an outer shell.

7. The method according to claim 1, wherein an outermost shell present in the second particulate material comprises oligomeric or polymeric constituents that are not bonded in a covalent manner to the second particulate material and are soluble on contact of the second particulate material with a solvent or a monomer.

8. The method according to claim 7, wherein the oligomeric or polymeric constituents were formed by the use of 0.1% to 8% by weight of a chain transfer agent in the monomer mixture for production of at least one shell of the second particulate material.

9. The method according to claim 1, wherein an outermost shell present in the second particulate material has been produced from a composition containing between 0.1% and 8% by weight of a chain transfer agent.

10. The method according to claim 4, wherein the core or the shell having a lower glass transition temperature is a phase which has been produced to an extent of at least 60% by weight from acrylates and has a glass transition temperature measured h DSC which is at least 40° C. below the glass transition temperature measured by DSC of the first particulate material.

11. The method according to claim 4, wherein the phase of the particulate polymer material having a higher glass transition temperature is a phase which has been produced to an extent of at least 60% by weight from MMA and has a glass transition temperature determined by means of DSC greater than 80° C.

12. The method according to claim 1, wherein the first and/or second particulate material comprises a particulate polymer material comprising an initiator suitable for curing the binder or a catalyst or accelerator that accelerates the curing.

13. The method according to claim 1, wherein a weight ratio of the first particles to the second particles in the powder bed is between 99:1 and 9:1.

14. The method according to claim 3, wherein the powder bed comprises at least two different particulate materials.

15. The method according to claim 3, wherein the core or shell having a lower glass transition temperature has a glass transition temperature less than 40° C., and in that the core and/or shell having a higher glass transition temperature has a glass transition temperature greater than 80° C.
